(19) United States
(12) Patent Application Publication
(10) Pub. No.: US 2001/0013829 A1
(43) Pub. Date: Aug. 16, 2001

(54) Alarm-triggering locking plate comprising a breaking plate

(76) Inventors: Erich Matouschek, Hulben (DE); Thomas Matouschek, Hulben (DE); Brigitte Walliser, Nurtingen (DE)

Correspondence Address: Lichti, Lempert, & Lasch, Bergwaldstr. 1, Karlsruhe, D-76227, DE

(21) Appl. No.: 09/783,080

(22) Filed: Feb. 15, 2001

(30) Foreign Application Priority Data
Feb. 16, 2000 (DE) 100 06 946.0

(51) Int. Cl. G08B 13/08

(52) U.S. Cl. 340/545.1; 340/693.5

(57) ABSTRACT

Alarm-triggering locking plate for the closing area of a door or window to be secured, comprising a first breaking plate (4) to be overcome by force, having at least one stop element (3), comprising a second fixing means for the locking plate (1) which is more difficult to overcome by force, and is designed as at least one counter stop element (12) anchored on a door or window frame, and means which trigger an alarm when the first fixing means has been overcome, wherein a motion of the front retaining part (3) in the opening direction (8) of the door or window is limited by the second fixing means (12) when the first fixing means (4) has been overcome.

This application claims Paris Convention priority of DE 100 06 946.0 filed Feb. 16, 2000 the complete disclosure of which is hereby incorporated by reference.

### BACKGROUND OF THE INVENTION

The invention concerns an alarm-triggering locking plate for securing the locking area of a door or window, according to the independent claim.

The principle function of this locking plate is that, in case of forceful intrusion, a first fixing means is initially overcome which, however, triggers an alarm. This is preferably a silent alarm which informs an alarm station concerning the intrusion. When the alarm has been triggered, the intruder is prevented from intruding into the building by the second fixing means which represents a larger encumbrance than the first fixing means. This second fixing means requires larger forces to be overcome, wherein the time required therefor allows assistants or the police to arrive at the location.

A locking plate, known from EP-A-0 293 952, is displaced, upon application of force, against a spring force and in the opening direction of the door until stop elements abut, in the opening direction, against lateral borders of the openings of an element. Such motion of the locking plate triggers an alarm. This known device has the disadvantage that the helical springs can already be overcome with relatively little force and there is the danger that the alarm is erroneously triggered during normal opening and closing of the door, at least when the springs lose their spring force due to aging or the like. A further disadvantage consists in that, upon application of force, an alarm is initially triggered through deflection of the locking plate. If the intruder interrupts his/her attempt to break in, the locking plate returns to its original position in response to the spring force and one cannot determine whether or not the alarm was triggered through an attempted intrusion or through electric malfunction. The intruder can use this fact to cause several so-called deceptive alarms, such that the intervening forces do not react after several such alarms. He/she can then break in without being disturbed.

In the German Patent 196 03 679, the lock directly abuts an alarm plate mounted transverse to the break-in direction which forms, together with the other locking points, a breaking point. In the event of attempted intrusion, the applied force causes the lock, and at the same time an alarm plate mounted transverse to the break-in direction, to break thereby causing an alarm. This approach does not present a clearly defined first resistance due to cooperation between several factors such as the fitting and the alarm plate designed as breaking point.

A further locking plate, known from EP 0 744 002, is divided into two parts which are held together by screws or bolts designed as breaking points. When force is applied in the opening direction of the door, the screws break or shear off the bolts and the door can be slightly opened until the stop elements abut the lateral borders of the openings of an element. This locking plate motion triggers an alarm. This known device has the disadvantage that particularly screws do not guarantee a permanently constant controlled resistance since they produce extremely differing resistances in dependence on tightening due to the pressing force between the two parts held together by the screw, and depending on the surface structure of the two parts. This may cause the resistance of the breaking point to be almost identical to that of the lock. The lock can thereby be forced together with the superposed breaking point in response to the intrusion. This would eliminate the time advantage between overcoming the breaking point, associated triggering of the alarm, and subsequent overcoming of the lock.

It is the object of the present invention to produce an alarm-triggering retaining device which can differentiate clearly between normal use and intrusion through a permanently constant first resistance.

### SUMMARY OF THE INVENTION

This object is achieved in accordance with the invention by the features of the independent claim. The locking plate in accordance with the invention can be used in a simple fashion and can therefore also be retrofitted.

Realization of the breaking points via a plate-shaped connection advantageously produces a simple and inexpensive fixing means which resists application of force up to a permanently constant and relatively large force, and is then irreversibly overcome, which facilitates realization of a defined triggering force and proof of attempted intrusion when an alarm has been triggered. These advantages can be realized in a simple and inexpensive fashion.

When breaking into a door or window, an intruder will not realize that an alarm safety device has been installed, especially if it includes a silent alarm. When the first fixing means has been overcome, a radio wave or telephone alarm is transmitted to a surveillance company which operates 24 hours a day. When, after overcoming the first fixing means, the intruder encounters the second fixing means which is more difficult to overcome, he/she will already give up at an early stage or be caught in the act, since the second retaining device restricts the amount of time available after triggering the alarm. He/she is likely to be arrested before getting into the building. The deterrent effect caused by this safety means facilitates long-term prevention which can considerably reduce damages. The additional costs and installation effort for mounting the inventive locking plates are relatively low, in particular for existing silent alarm systems.

The measures mentioned in the dependent claims permit advantageous further developments and improvements of the locking plate in accordance with the invention.

In an advantageous constructive design, the locking plate, which consists of two parts and is anchored on the door or window frame, comprises a breaking plate as first fixing means. When the breaking plate used as the first retaining device breaks, the locking plate can be displaced in the opening direction until the front retaining part reaches the next stop which acts as counter stop element and only then presents an increased resistance to a further opening motion.

In the present example, a front and rear retaining part are mounted in the locking plate, wherein the rear retaining part is rigidly anchored to the window or door frame. The front retaining part is connected to the rear retaining part via a breaking plate and is rigidly positionally fixed thereby.

Advantageously and as known per se, the alarm-triggering means are current and/or voltage-loaded breaking wires or magnetically or mechanically triggered electric switches which issue an alarm signal in response to relative motion of the locking plate.

The drawing shows embodiments of the invention which are explained in more detail in the following description.

### BRIEF DESCRIPTION OF THE DRAWING

FIG. 1 shows a sectional representation of an embodiment of the invention; and

FIG. 2 shows a front view of a rupturing alarm plate.

### DESCRIPTION OF THE PREFERRED EMBODIMENT

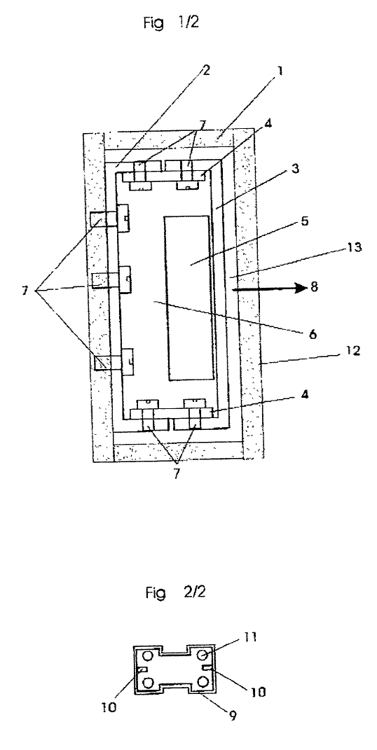

FIG. 1 shows section of an embodiment of the invention. The rear retaining part 2 is rigidly screwed into a locking plate 1 of a door or a window by means of screws 7. The front retaining part 3 is rigidly connected to the rear retaining part 2 by means of the breaking plates 4. The breaking plate 4 keeps the rear and front retaining part together via screws 7. An arrow 8 characterizes the opening direction of the door or window (not shown). The lock 5 is in the free space 6 located behind the front retaining part 3 as viewed in the direction of intrusion 8, which secures the door or window (not shown) against opening.

In case of attempted forceful intrusion, the force applied is transferred via the lock 5 onto the front retaining part 3 and is transferred by same to the breaking plate 4 which breaks after a previously defined exerted force. When the breaking plate 4 has broken, the front retaining part 3 moves in the breaking direction 8 due to the force applied and abuts the stop element 12 after passing through the free space 13. This stop element 12 may be the locking plate 1, which presents a considerably larger mechanical resistance to the intruder and which requires valuable time to overcome.

When the breaking plate 4 has been destroyed, the relative motion of the front retaining part 3 triggers an alarm signal via conventional alarm triggering means, such as a magnetic switch or mechanically triggered electrical switches etc., which calls for help via radio waves, telephone or a siren. When the front retaining part 3 has hit the stop element 12 and an alarm has been triggered, the intruder is pressed for time due to the increased resistance and assisting individuals can reach the intrusion location and arrest the intruder, possibly before he/she gets into the building.

FIG. 2 shows a front view of an alarm plate functioning as a breaking plate 4. The bores rigidly connect and fix the front and rear retaining part 2, 3 through screws 7. In this embodiment, the breaking plate 4 comprises alarm wires 9 which are disconnected when the breaking plate 4 is destroyed thereby safely triggering an alarm. These alarm wires 9 are connected per wire or radio waves to an alarm station (not shown) via terminals 10 which define interruption of the current conductors 9 and of the current flow as an alarm.

The breaking plate 4 can, of course, be made from various materials such as metal, plastic etc. and can be used without mounted current conductors 9. In this case, conventional alarm-triggering means are used for triggering an alarm as described above. The presented invention can moreover be used for securing all openings of an object. The solution shown in FIGS. 1 and 2 is not exhaustive.

All embodiments of the solution forming the basis of the present invention have the aim that the connections between the two retaining parts 2 and 3, designed as breaking plates 4, must be dimensioned such that they can be easily overcome in case of attempted intrusion but on the other hand safely resist the normal daily strain.

We claim:

1. An alarm-triggering locking device for securing a closing area of a door or window, the door or window having a frame to which it is mounted for an opening motion relative thereto, the device comprising:
a breaking member;
means for attaching said breaking member to the frame;
a first retaining member mounted to a front side of said bearing member;
a second retaining member;
means for mounting said second retaining member to the frame at a front separation from said first retaining member; and
alarm means communicating with at least one of said breaking member and said first retaining member, wherein said breaking member ruptures in response to a first outward force to release said first retaining member for abutting against said second retaining member, thereby triggering said alarm means, wherein at least one of said second retaining member and said second retaining member mounting means first rupture in response to a second outward force which is greater than said first outward force.

2. The locking device of claim 1, wherein said alarm means comprise an alarm member disposed between said first retaining member and said second retaining member for triggering said alarm means when said breaking member ruptures.

3. The device of claim 1, wherein said alarm means comprise contact means mounted to said breaking member, said contact means triggering said alarm means when said breaking member ruptures.

4. The device of claim 3, wherein said contact means rupture to trigger said alarms means.

5. The locking device of claim 1, wherein said alarm means comprise trigger means having at least one of a current loaded breaking wire, a voltage loaded breaking wire, a magnetically triggered electrical switch, and a mechanically triggered electrical switch.
